(19) United States
(12) Patent Application Publication
(10) Pub. No.: US 2025/0055132 A1
(43) Pub. Date: Feb. 13, 2025

(54) STRETCHED MULTILAYER CATION EXCHANGE MEMBRANES

(71) Applicant: THE CHEMOURS COMPANY FC, LLC, WILMINGTON, DE (US)

(72) Inventors: RUIDONG YANG, HOCKESSIN, DE (US); ROBERT HARVEY MOFFETT, LANDENBERG, PA (US); MICHAEL W. RAIFORD, HOCKESSIN, DE (US); ALLISON HALUCKA, SARASOTA, FL (US)

(73) Assignee: THE CHEMOURS COMPANY FC, LLC, WILMINGTON, DE (US)

(21) Appl. No.: 18/720,863

(22) PCT Filed: Dec. 20, 2022
(86) PCT No.: PCT/US2022/053435

§ 371 Date: Jun. 17, 2024

Related U.S. Application Data
(60) Provisional application No. 63/292,083, filed on Dec. 21, 2021.

(51) Int. Cl. H01M 50/449; H01M 8/18; H01M 50/403; H01M 50/426; H01M 50/497

(52) U.S. Cl. CPC H01M 50/449; H01M 8/188; H01M 50/403; H01M 50/426; H01M 50/497

(57) ABSTRACT

A cation exchange membrane includes a stretched film including at least two layers of fluorinated ionomer containing sulfonate or sulfonic acid groups. The layers have differing ion exchange ratio values, which define one or more high ion exchange ratio layers and one or more low ion exchange ratio layers. The high and low ion exchange ratio layers differ in ion exchange ratio by at least about 1. A process for making a cation exchange membrane includes forming a film including at least two layers of fluorinated ionomer containing sulfonate or sulfonic acid groups to form a multi-layer film and stretching the multi-layer film. An electrochemical cell has anode and cathode compartments and includes a cation exchange membrane as a separator between said anode and cathode compartments, where the membrane includes a stretched film including at least two layers of fluorinated ionomer containing sulfonate or sulfonic acid groups.

### CROSS REFERENCE TO RELATED APPLICATIONS

This application is a national filing under 35 U.S.C. 371 of International Application No. PCT/US2022/053435 filed Dec. 20, 2022, and claims the benefit of priority of U.S. Provisional Application No. 63/292,083 filed Dec. 21, 2021, the disclosures of which are incorporated herein by reference in its entirety.

### FIELD OF THE INVENTION

This invention relates to ion exchange membranes for electrochemical cells and more particularly to stretched multilayer cation exchange membranes for vanadium redox flow battery cells.

### BACKGROUND OF THE INVENTION

A flow battery is a form of rechargeable battery in which electrolyte containing one or more dissolved electroactive species flows through an electrochemical cell that converts chemical energy directly to electricity. Additional electrolyte is stored externally, generally in tanks, and is usually pumped through the cell, or cells, of the reactor, although gravity feed systems are also possible. Flow batteries can be rapidly recharged by replacing the electrolyte liquid while simultaneously recovering the spent material for re-energization.

Three main classes of flow batteries are the redox (reduction-oxidation) flow battery, the hybrid flow battery, and the fuel cell. In the redox flow battery, all of the electroactive components are dissolved or dispersed in the electrolyte. The hybrid flow battery is differentiated in that one or more of the electroactive components is deposited as a solid layer. The redox fuel cell has a conventional flow battery reactor, but the flow battery reactor only operates to produce electricity; it is not electrically recharged. In the latter case, recharge occurs by reduction of the negative electrolyte using a fuel, such as hydrogen, and oxidation of the positive electrolyte using an oxidant, such as air or oxygen.

The vanadium redox flow battery is an example of a redox flow battery, which, in general, involves the use of two redox couple electrolytes separated by an ion exchange membrane. The family of vanadium redox flow batteries includes so-called “All-Vanadium Redox Flow Batteries” (VRB) that employ a V(II)/(III) couple in the negative half-cell and a V(IV)/V(V) couple in the positive half-cell and “Vanadium Bromide Redox Flow Cells and Flow Batteries” (V/BrRB) that employ the V(II)/V(III) couple in the negative half-cell and a bromide/polyhalide couple in the positive half-cell. In either case, the positive and negative half-cells are separated by a membrane/separator, which prevents cross mixing of the positive and negative electrolytes, whilst allowing transport of ions to complete the circuit during passage of current.

The V(V) ions in the VRB system and the polyhalide ions in the V/BrRB system are highly oxidizing and result in rapid deterioration of most polymeric membranes during use, leading to poor durability. Consequently, potential materials for the membrane/separator have been limited and this remains a main obstacle to commercialization of these types of energy storage systems. Ideally, the membrane should be stable to the acidic environments of electrolytes such as vanadium sulfate (often with a large excess of free sulfuric acid) or vanadium bromide, show good resistance to the highly oxidizing V(V) or polyhalide ions in the charged positive half-cell electrolyte, have a low electrical resistance, have a low permeability to the vanadium ions or polyhalide ions, have a high permeability to charge carrying hydrogen ions, have good mechanical properties, and be low cost. To date, developing a polymer system suitable with respect to this property balance has remained challenging.

Certain perfluorinated ion exchange polymers such as the perfluorosulfonate polymers (for example, Nafion™ polymers, available from The Chemours Company FC, LLC, Wilmington, DE) show exceptional promise in terms of resistance to acidic environments and highly oxidizing species but show room for further improvement in water and vanadium ion crossover resistance. High vanadium ion crossover results in low coulombic efficiencies, capacity fade, and even self-discharge of the battery, as well as a continuing need to rebalance the electrolyte concentrations in the two half cells. Because of this unwanted capacity fade due to the mix of electroactive ions, the entire battery must be made larger to meet the targeted discharge capacity during times of reduced capacity. Furthermore, the crossover is typically suppressed by using a thicker membrane, which also suppresses proton conductance and significantly increases the cost. This puts flow battery manufacturers at a significant competitive disadvantage relative to manufacturers of other batteries with higher coulombic efficiencies. Clearly, there is a significant incentive to improve the coulombic efficiency of the cell, and the primary way to achieve this is via improved crossover resistance and improved ionic selectivity of the charge-carrying species versus electroactive species.

So et al. (“Hydrophilic Channel Alignment of Perfluoronated Sulfonic-Acid Ionomers for Vanadium Redox Batteries”, ACS Appl. Mater. Interfaces, Vol. 10, pp. 19689-19696, 2018) discloses uniaxial stretching that provides a higher Coulombic efficiency and a longer self-discharge time but also a decreased proton conductivity.

Karpushkin et al. (“Effect of biaxial stretching on the ion-conducting properties of Nafion membranes”, Mendeleev Commun., Vol. 26, pp. 117-118, 2016) discloses biaxial stretching at various draw ratios leading to a reduced vanadium permeability but also a decreased self-discharge time.

Grot (EP U.S. Pat. No. 145,426) describes the making of chloroalkali membranes that are extended in at least one planar direction by swelling or stretching.

### SUMMARY OF THE INVENTION

There is a need for ion exchange membranes having a reduced vanadium crossover, an improved energy efficiency, a reduced self-discharge rate, and/or an increased ionic selectivity.

In one embodiment of the process, a cation exchange membrane includes a stretched film including at least two layers of fluorinated ionomer containing sulfonate or sulfonic acid groups. The layers have differing ion exchange ratio (IXR) values, which define one or more high ion exchange ratio layers and one or more low ion exchange ratio layers. The high and low ion exchange ratio layers differ in ion exchange ratio by at least about 1.

In another embodiment, a process makes a cation exchange membrane comprising a stretched film. The process includes forming a film including at least two layers of fluorinated ionomer containing sulfonate or sulfonic acid groups to form a multi-layer film. The process also includes stretching the multi-layer film. The layers have differing ion exchange ratio values, which define one or more high ion exchange ratio layers and one or more low ion exchange ratio layers. The high and low ion exchange ratio layers differ in ion exchange ratio by at least about 1.

In yet another embodiment, an electrochemical cell has anode and cathode compartments and includes a cation exchange membrane as a separator between the anode and cathode compartments. The membrane includes a stretched film comprising at least two layers of fluorinated ionomer containing sulfonate or sulfonic acid groups. The layers have differing ion exchange ratio values, which define one or more high ion exchange ratio layers and one or more low ion exchange ratio layers. The high and low ion exchange ratio layers differ in ion exchange ratio by at least about 1.

Other features and advantages of the present invention will be apparent from the following more detailed description of the preferred embodiments, taken in conjunction with the accompanying drawings which illustrate, by way of example, the principles of the invention.

### BRIEF DESCRIPTION OF THE DRAWING

FIG. 1 is a schematic view of an electrochemical cell in an embodiment of the present disclosure.

### DETAILED DESCRIPTION OF THE INVENTION

Provided are stretched multilayer ion exchange membranes having a low vanadium crossover, a high energy efficiency, a low self-discharge rate, a high ionic selectivity, increased mechanical strength, reduced in-plane dimensional expansion in the x-y direction, or combinations thereof.

In exemplary embodiments, a cation exchange membrane includes a stretched film including at least two layers of fluorinated ionomer containing sulfonate or sulfonic acid groups. The layers have differing ion exchange ratio (IXR) values, which define one or more high ion exchange ratio layers and one or more low ion exchange ratio layers. The high and low ion exchange ratio layers differ in ion exchange ratio by at least about 1.

As used herein, stretched film refers to a film that has been stretched by a stretching ratio greater than 1.0 in at least one direction. In some embodiments, the at least one direction is a machine direction and/or a transverse direction.

As used herein, stretching ratio refers to the ratio of the stretched length of the film to the unstretched length of the film.

As used herein, machine direction refers to the in-plane direction of a film parallel to a direction of travel or wind-up on a roll of the membrane during manufacture of the film.

As used herein, transverse direction refers to the in-plane direction of a film perpendicular to the machine direction.

As used herein, ion exchange ratio (IXR) refers to the number of carbon atoms in the ionomer backbone in relation to the number of cation exchange groups. In some embodiments, the IXR of an ionomer can be related to its equivalent weight (EW) by the equation EW=(50×IXR)+MW_{sc}−19, where MW_{sc} is the molecular weight of the side chain of the ionomer.

As used herein, equivalent weight (EW) refers to the weight of the ionomer in proton form required to neutralize one equivalent of NaOH.

As used herein, sulfonate or sulfonic acid groups refers to either sulfonic acid groups or salts of sulfonic acid, preferably alkali metal or ammonium salts. Preferred functional groups are represented by the formula —SO₃X wherein X is H, Li, Na, K or N (R¹)(R²)(R³)(R⁴) and R¹, R², R³, and R⁴ are the same or different and are H, CH₃, or C₂H₅. A class of preferred fluorinated ionomers containing sulfonate or sulfonic acid groups for one or more layers of the present multi-layer stretched films include a highly fluorinated, most preferably perfluorinated, carbon backbone and the side chain is represented by the formula —(O—CF₂CFR^{f})ₐ—O—CF₂CFR′^{f}SO₃X, where R^{f} and R′^{f} are independently selected from F, Cl, or a perfluorinated alkyl group having 1 to 10 carbon atoms, a=0, 1 or 2, and X is H, Li, Na, K or N (R¹) (R²) (R³) (R⁴) and R¹, R², R³, and R⁴ are the same or different and are H, CH₃, or C₂H₅. Preferred fluorinated ionomers containing sulfonate or sulfonic acid groups for one or more layers of the present multi-layer stretched films may include, for example, polymers disclosed in U.S. Pat. No. 3,282,875, in U.S. Pat. No. 4,358,545, or in U.S. Pat. No. 4,940,525. For use in vanadium redox flow batteries and fuel cells, fluorinated ionomer in the membrane is typically employed in the proton form, i.e., X is H.

One preferred fluorinated ionomer containing sulfonate or sulfonic acid groups for one or more layers of the present multi-layer stretched films includes a perfluorocarbon backbone and a side chain represented by the formula —O—CF₂CF(CF₃)—O—CF₂CF₂SO₃X, where X is as defined above. When X is H, the side chain is —O—CF₂CF(CF₃)—O—CF₂CF₂SO₃H. Fluorinated ionomers containing sulfonate or sulfonic acid groups of this type are disclosed in U.S. Pat. No. 3,282,875 and may be made by copolymerization of tetrafluoroethylene (TFE) and the perfluorinated vinyl ether CF₂═CF—O—CF₂CF(CF₃)—O—CF₂CF₂SO₂F, perfluoro (3,6 dioxa-4 methyl 7 octenesulfonyl fluoride) (PSEPVE), followed by conversion to sulfonate groups by hydrolysis of the sulfonyl fluoride groups and conversion to the proton form if desired for the particular application.

One preferred fluorinated ionomer containing sulfonate or sulfonic acid groups for one or more layers of the present multi-layer stretched films of the type disclosed in U.S. Pat. Nos. 4,358,545 and 4,940,525 has the side chain —O—CF₂CF₂SO₃X, where X is as defined above. This fluorinated ionomer containing sulfonate or sulfonic acid groups for one or more layers of the present multi-layer stretched films may be made by copolymerization of TFE and the perfluorinated vinyl ether CF₂═CF—O—CF₂CF₂SO₂F, perfluoro(3 oxa-4-pentenesulfonyl fluoride) (PFSVE), followed by hydrolysis and conversion to the proton form if desired for the particular application. When X is H, the side chain is —O—CF₂CF₂SO₃H.

In exemplary embodiments, the fluorinated ionomer containing sulfonate or sulfonic acid groups for one or more layers of the present multi-layer stretched films is of the type available under the trade name of Nafion™ (The Chemours Company FC, LLC, Wilmington, DE).

In some embodiments, the stretched film has an apparent ion exchange ratio in the range of about 7.1 to about 25.2, alternatively about 9.1 to about 23.2, alternatively about 9.1 to about 21.2, alternatively about 11.1 to about 19.2, alternatively about 12.1 to about 19.2, or alternatively about 12.1 to about 15.2, or any value, range, or sub-range therebetween. As used herein, apparent ion exchange ratio refers to the layer thickness-weighted average ion exchange ratio of a multilayer film based on the film thickness prior to stretching. In other words, the apparent ion exchange ratio is the sum of the thickness percentage multiplied by the ion exchange ratio for each of the layers.

In some embodiments, the stretched film has an apparent equivalent weight in the range of about 700 to about 1600, alternatively about 800 to about 1500, alternatively about 800 to about 1400, alternatively about 900 to about 1300, alternatively about 950 to about 1300, alternatively about 950 to about 1100, or any value, range, or sub-range therebetween. As used herein, apparent ion exchange ratio refers to the layer thickness-weighted average IXR of a multilayer film. As used herein, apparent EW refers to the layer thickness-weighted average EW of a multilayer film based on the film thickness prior to stretching.

In exemplary embodiments, the fluorinated ionomer containing sulfonate or sulfonic acid groups for one or more layers of the present multi-layer stretched films is made by the copolymerization of TFE and PSEPVE followed by hydrolysis and ion exchange into proton form. Such membranes possesses a side chain represented by the formula —O—CF₂CF(CF₃)—O—CF₂CF₂SO₃H and have an EW in the range of about 600 to about 1600, alternatively about 700 to about 1600, alternatively about 850 to about 1500, alternatively about 800 to about 1400, alternatively about 900 to about 1300, alternatively about 950 to about 1300, alternatively about 950 to about 1100, or any value, range, or sub-range therebetween. The IXR for a fluorinated ionomer with the side chain —O—CF₂—CF(CF₃)—O—CF₂—CF₂—SO₃H, i.e., produced from a copolymer of TFE and PSEPVE, can be related to EW using the following formula: 50 IXR+344=EW.

In exemplary embodiments, the fluorinated ionomer containing sulfonate or sulfonic acid groups for one or more layers of the present multi-layer stretched films is made by the copolymer of TFE and PFSVE, followed by hydrolysis and ion exchange into proton form. Such membrane possesses a side chain represented by the formula —O—CF₂CF₂SO₃H and has an EW in the range of about 400 to about 1600, alternatively about 530 to about 1440, alternatively about 630 to about 1340, alternatively about 630 to about 1240, alternatively about 730 to about 1140, alternatively about 780 to about 1140, alternatively about 780 to about 940, or any value, range, or sub-range therebetween. Such ionomers may be referred to as short side chain ionomers. The IXR for a fluorinated ionomer with the side chain —O—CF₂CF₂SO₃H, i.e., produced from a copolymer of TFE and PFSVE, can be related to equivalent weight using the following formula: 50 IXR+178=EW.

In some embodiments, the high and low ion exchange ratio layers of fluorinated ionomer containing sulfonate or sulfonic acid groups differ in ion exchange ratio by at least about 1, alternatively by at least about 2, alternatively by between about 1 and about 15, alternatively by at least about 3, alternatively by at least about 5, alternatively by at least about 10, or any value, range, or sub-range therebetween.

In some embodiments, the high and low ion exchange ratio layers of fluorinated ionomer containing sulfonate or sulfonic acid groups differ in equivalent weight by at least about 50, alternatively at least about 100, alternatively at least about 200, or any value, range, or sub-range therebetween.

In some embodiments, the one or more low ion exchange ratio layer has an ion exchange ratio of at most about 17.2, alternatively at least about 9.1, alternatively in the range of about 9.1 to about 17.2, alternatively at most about 15.2, alternatively at most about 13.2, alternatively at most about 15.2, or any value, range, or sub-range therebetween.

In some embodiments, the one or more low ion exchange ratio layer has an equivalent weight of at most about 1200, alternatively at least about 800, alternatively in the range of about 800 to about 1200, alternatively at most about 1100, alternatively at most about 1000, alternatively at most about 900, or any value, range, or sub-range therebetween.

In some embodiments, the one or more high ion exchange ratio layer has an ion exchange ratio of at least about 11.1, alternatively at most about 23.2, alternatively in the range of about 11.1 to about 23.2, alternatively at least about 13.1, alternatively at least about 17.1, or any value, range, or sub-range therebetween.

In some embodiments, the one or more high ion exchange ratio layer has an equivalent weight of at least about 900, alternatively at most about 1500, alternatively in the range of about 900 to about 1500, alternatively at least about 1000, alternatively at least about 1200, or any value, range, or sub-range therebetween.

In some embodiments, the stretched film is biaxially stretched. As used herein, biaxially stretched refers to stretched in a machine direction and a transverse direction perpendicular to the machine direction.

In other embodiments, the stretched film is uniaxially stretched. As used herein, uniaxially stretched refers to stretched only in a single direction, preferably a machine direction.

In some embodiments, the stretched film includes at least two high ion exchange ratio layers. In some embodiments, the at least two high ion exchange ratio layers have equivalent ion exchange ratios.

In some embodiments, the thickness of the one or more low ion exchange ratio layers is greater than or equal to the thickness of the one or more high ion exchange ratio layers.

In some embodiments, the membrane thickness after stretching is in the range of about 10 μm to about 200 μm, alternatively about 15 μm to about 100 μm, alternatively about 20 μm to about 50 μm. As used herein, membrane thickness refers to the total dry thickness of the membrane after stretching. In some embodiments, the membrane is unreinforced.

In exemplary embodiments, the membrane has vanadyl ion permeability, in units of 10⁻⁶ cm²/min, of less than about 1.5, alternatively less than about 1.4, alternatively less than about 1.2, alternatively less than about 1.0, alternatively less than about 0.8, alternatively less than about 0.6, or any value, range, or sub-range therebetween. As used herein, vanadyl ion (VO²⁺) permeability refers to the permeability of VO²⁺ vanadyl ions through a film in the direction perpendicular to the plane of the film.

In exemplary embodiments, the membrane has an ionic selectivity, in units of (mS cm⁻¹)/(10⁻⁶ cm² min⁻¹), of at least about 50, alternatively at least about 60, alternatively at least about 70, alternatively at least about 80, alternatively at least about 90, alternatively at least about 100, alternatively at least about 110, or any value, range, or sub-range therebetween. As used herein, ionic selectivity refers to the permeability of a proton relative to a vanadyl ion through a film in the direction perpendicular to the plane of the film, expressed as through-plane conductivity divided by vanadyl ion permeability. As used herein, through-plane conductivity refers to the proton conductivity of a film in the direction perpendicular to the plane of the film.

In some embodiments, a process for making a cation exchange membrane including a stretched film includes forming a film including at least two layers of fluorinated ionomer containing sulfonate or sulfonic acid groups to form a multi-layer film. The process also includes stretching the multi-layer film.

In some embodiments, the forming includes hot pressing at least two unhydrolyzed (sulfonyl fluoride form) films of fluorinated ionomer at a hot pressing temperature in the range of about 200° C. to about 250° C. under a pressure in the range of about 3500 to 5000 pounds of force for about 5 to 7 minutes. The individual unhydrolyzed (sulfonyl fluoride form) films may be formed by extruding a polymer film. In other embodiments, the forming includes coextrusion of at least two unhydrolyzed (sulfonyl fluoride form) films of fluorinated ionomer containing sulfonate or sulfonic acid groups. In some embodiments, the forming includes hydrolyzing and acid exchanging the hot-pressed or coextruded multi-layer film prior to the stretching. In other embodiments, the multi-layer film is produced by casting an ionomer dispersion of ionomers of differing IXR followed by a drying step.

In exemplary embodiments, the main chain of the fluorinated ionomer containing sulfonate or sulfonic acid groups for one or more layers of the present multi-layer stretched films has a glass transition temperature in the range of about 100° C. to about 125° C., and the side chains have a glass transition temperature in the range of about 190° C. to about 245° C. In exemplary embodiments, the process includes heating the multi-layer film to a temperature not lower than about 20° C. below the glass transition temperature of the main chain of the fluorinated ionomer, alternatively not lower than about 10° C. below, alternatively greater than the glass transition temperature of the main chain of the ionomer film, or any value, range, or sub-range therebetween. In exemplary embodiments, the stretching occurs at a temperature, with respect to the glass transition temperature of the main chain of the ionomer film, greater than about 20° C. below, alternatively greater than about 10° C. below, alternatively greater than the glass transition temperature of the main chain of the ionomer film, or any value, range, or sub-range therebetween. In exemplary embodiments, the stretching occurs at a temperature in the range of about 70° C. to about 250° C., alternatively about 75° C. to about 150° C., alternatively about 80° C. to about 140° C., or any value, range, or sub-range therebetween.

In exemplary embodiments, the stretching is carried out at a rate in the range of about 1% per second (%/sec) to about 200%/sec, alternatively about 1%/sec to about 50%/sec, alternatively about 1%/sec to about 40%/sec, alternatively about 1%/sec to about 30%/sec, alternatively about 1%/sec to about 20%/sec, alternatively about 5%/sec to about 20%/sec, alternatively about 1%/sec to about 10%/sec, alternatively about 10%/sec to about 20%/sec, alternatively about 20%/sec to about 30%/sec, or any value, range, or sub-range therebetween.

In some embodiments, the stretching includes sequentially stretching first in the machine direction and then in the transverse direction. In other embodiments, the stretching occurs simultaneously in the machine direction and in the transverse direction. In other embodiments, the stretching occurs only in the machine direction.

In exemplary embodiments, the stretching includes stretching in both the machine direction and the transverse direction each at a stretching ratio in the range of about 1.1 to about 5, alternatively about 1.2 to about 2, alternatively about 1.2 to about 2.5, alternatively about 2 to about 5, alternatively about 2 to about 3.5, alternatively about 2 to about 3, alternatively about 2 to about 2.5, alternatively about 1.7 to about 3, alternatively about 1.7 to about 2, or any value, range, or sub-range therebetween.

In exemplary embodiments, the process further includes annealing the film after the stretching. The annealing includes heating the film for a period of about 5 seconds to about 30 minutes to a temperature in the range of about 0° C. to about 300° C., alternatively about 25° C. to about 200° C., alternatively about 50° C. to about 200° C., alternatively about 85° C. to about 200° C., alternatively about 100° C. to about 190° C., alternatively about 125° C. to about 160° C., or any value, range, or sub-range therebetween, while providing tension sufficient to hold the film in a stretched condition. In some embodiments, the annealing further includes partially releasing the tension in the transverse direction such that the width of the film in the transverse direction decreases by no more than 10%.

In some embodiments, a film-stretching machine stretches the film. In some embodiments, the film-stretching machine is a biaxial film stretching machine for stretching the film in a machine direction and/or in a transverse direction either simultaneously or sequentially. In some embodiments, the film is stretched at a temperature in the range of about 125° C. to about 150° C., alternatively about 140° C., or any value, range, or sub-range therebetween. In some embodiments, the film is subsequently annealed at a temperature in the range of about 140° C. to about 160° C., alternatively about 150° C., or any value, range, or sub-range therebetween.

In some embodiments, a film-stretching machine stretches the film in the machine direction. The film is fed into the machine at a predetermined rate, such as, for example, 5 feet per minute. Stretching is accomplished by passing the film over two pre-heating rolls for heating the film followed by a slow roll and fast roll for stretching the film. The slow roll and the fast roll provide a predetermined stretching ratio. The film may then pass over an annealing roll followed by a cooling roll. In some embodiments, the temperatures of the rolls are about 150° F. (about 66° C.) for the first pre-heat roll, about 230° F. (about 110° C.) for the second pre-heat roll and the slow roll, about 225° F. (about 107° C.) for the fast roll, about 180° F. (about 82° C.) for the annealing roll, and about 82° F. (about 28° C.) for the cooling roll.

In some embodiments, the film is stretched in the transverse direction by a tenter process after stretching in the machine direction. The film is fed into a tenter oven and securely gripped by clips on both edges. The tenter oven contains three sequential regions: preheating, stretching, and annealing. The temperature in each region is separately controlled, such as, for example, at about 300° F. (about 149° C.) for the preheating region, the stretching oven at about 290° F. (about 143° C.) for the stretching region, and about 285° F. (about 141° C.) for the annealing region. The transverse stretching occurs over a predetermined distance at a predetermined stretching ratio, such as, for example, a distance of about 9.5 feet and a stretching ratio of about 2.5. The film was allowed to relax by a predetermined amount, such as, for example, about 0.01%, in the annealing oven. After the annealing, the edges of the film may be trimmed and the film may be wound onto a cardboard core.

Films and membranes of the present disclosure may be used in any of a number of different applications, including, but not limited to, electrochemical cells, flow batteries, vanadium redox flow batteries, water electrolysis, direct methanol fuel cells, hydrogen fuel cells, or carbon dioxide electrolysis.

In some embodiments, an electrochemical cell having anode and cathode compartments includes a cation exchange membrane as a separator between the anode and cathode compartments. The membrane includes a stretched film including at least two layers of fluorinated ionomer containing sulfonate or sulfonic acid groups.

In some embodiments, the electrochemical cell is a redox flow battery cell, a fuel cell, a chloralkali cell, or a water electrolysis cell.

In some embodiments, the electrochemical cell is a redox flow battery cell. In some embodiments, the redox flow battery cell is a vanadium redox flow battery cell.

In some embodiments, the electrochemical cell is a fuel cell. In some embodiments, the fuel cell is a direct methanol fuel cell.

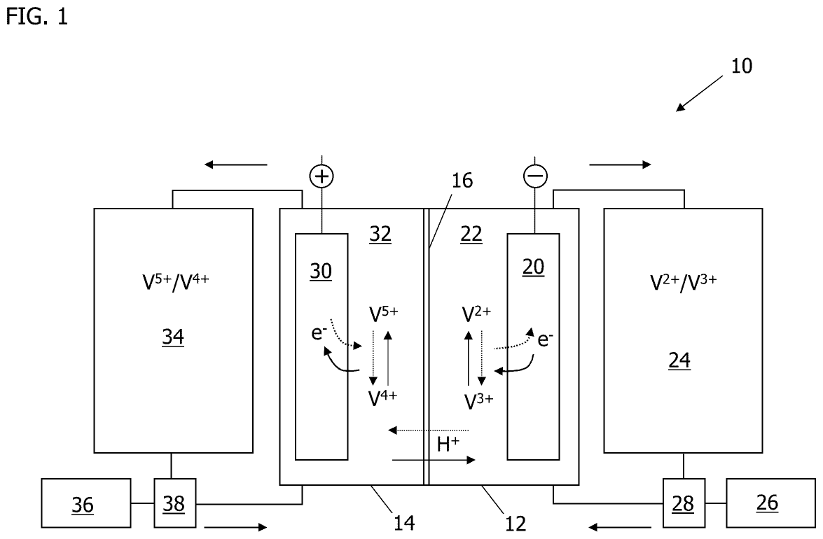

FIG. 1 shows an electrochemical cell 10 having an anode compartment 12 and a cathode compartment 14 and including a cation exchange membrane 16 as disclosed herein as a separator between the anode compartment 12 and the cathode compartment 14. In some embodiments, the electrochemical cell 10 is a flow battery. In some embodiments, the flow battery is a vanadium redox flow battery or an all vanadium redox flow battery.

The anode compartment 12 contains the anode 20 and anolyte 22. Additional anolyte 22 is stored in an anolyte tank 24 and may be supplied to the anode compartment 12 by way of an anolyte pump 26, with an anolyte valve 28 controlling the direction of flow.

The cathode compartment 14 contains the cathode 30 and catholyte 32. Additional catholyte 32 is stored in a catholyte tank 34 and may be supplied to the cathode compartment 14 by way of a catholyte pump 36, with a catholyte valve 38 controlling the direction of flow.

### TEST METHODS

### Determination of Through-Plane Conductivity

For the determination of the through-plane (proton) conductivity, the film was soaked in a 60° C. deionized water bath for 6 hours. The membrane was then immediately transferred to a covered container filled with the testing electrolyte (2.5 M sulfuric acid) and allowed to soak overnight. A customized H-cell was utilized for the measurement. The electric resistance was measured via an electrochemical impedance spectroscopy (EIS) technique by a four-electrode setup on a BioLogic potentiostat (BioLogic Sciences Instruments, Seyssinet-Pariset, France).

The cell was first assembled without a membrane and filled with 2.5 M sulfuric acid to measure the non-membrane ohmic resistance or the cell resistance, R_{cell}(Ω). The total resistance, Rₜₒₜₐₗ(Ω), was measured with the membrane affixed in the H-Cell, with equal amounts of test solution added to both sides of the assembled cell. The resistance of the membrane, R_{membrane}(Ω), is the difference between the total resistance and the cell resistance.

The through-plane conductivity of the membrane, OT (mS/cm), was calculated using Equation 1:

$${σ}_{T} = \frac{T}{A \times {R}_{membrane}} \qquad ( 1 )$$

where T is the thickness of the membrane, and A is the tested area of the membrane.

### Determination of Vanadyl Ion Permeability

For the determination of the vanadyl ion permeability, the film was soaked in a 60° C. deionized water bath for 6 hours. The membrane was then immediately transferred to a covered container filled with the testing electrolyte (1.5 M MgSO₄ in 2.5 M sulfuric acid) and allowed to soak overnight. A customized H-cell was utilized for the measurement. One side of the cell was filled with 1.5 M MgSO₄ in 2.5 M sulfuric acid electrolyte solution, and the counter compartment of the cell was filled with the same volume of 1.5 M VOSO₄ in 2.5 M sulfuric acid electrolyte solution. A UV-Vis probe was inserted into the MgSO₄ electrolyte side to monitor the intensity of the absorbing peak at 760 nm, which is associated with the VO²⁺ ion diffused from the VOSO₄ electrolyte. The vanadyl ion permeability, P_{VO}²⁺, was calculated using Equation 2:

$${P}_{{VO}^{2 +}} = \frac{V \times T}{- 2 A \times t} ln [ 1 - 2 \frac{{C}_{t}}{{C}_{{VO}^{2 +}}} ] \qquad ( 2 )$$

where V is the electrolyte volume on each side in cm³, T is the membrane thickness in cm, A is the tested area of the membrane in cm², t is the sampling time in min, Cₜ is the concentration of the VO²⁺ at sampling time t, and C_{Vo}²⁺ is the initial vanadyl concentration. The vanadyl ion permeability is in the units of 10⁻⁶ cm²/min.

### Determination of Ionic Selectivity

The ionic selectivity was calculated from the determined values for the through-plane conductivity of the membrane and the vanadyl ion permeability using Equation 3:

$$ionic selectivity = \frac{{σ}_{T}}{{P}_{{VO}^{2 +}}} \qquad ( 3 )$$

where the ionic selectivity is in the units of (mS cm⁻¹)/(10⁻⁶ cm² min⁻¹) or equivalently 10⁶ mS min/cm³.

### EXAMPLES

### Comparative Examples

Four comparative examples were prepared and tested for comparison to the inventive examples. The first comparative example (C1) was a cast single layer film of a TFE/PSEPVE ionomer containing sulfonic acid groups. The film of C1 was cast from an ionomer dispersion. The second comparative example (C2) was a stretched single layer film of a TFE/PSEPVE ionomer containing sulfonic acid groups. C2 was extruded then hydrolyzed and acid exchanged to convert to sulfonic acid groups prior to stretching. The third comparative example (C3) was a coextrusion of a first film of a first thickness (T1) of a TFE/PSEPVE ionomer containing sulfonic acid groups having a first ion exchange ratio (IXR1) and a second film of a second thickness (T2) of a TFE/PSEPVE ionomer containing sulfonic acid groups having a second ion exchange ratio (IXR2) less than the first ion exchange ratio (IXR1). The fourth comparative example (C4) was an extruded single layer film of a TFE/PSEPVE ionomer containing sulfonic acid groups. Comparative Examples C3 and C4 were hydrolyzed and acid exchanged to convert to sulfonic acid groups after extrusion. Film thicknesses and membrane thicknesses were measured with a Mitutoyo ID-S1112EX Measurement Indicator (Mitutoyo Corporation, Kawasaki, Japan). Table 1 shows the equivalent weight, ion exchange ratio, and thickness for the layers of each comparative example. Table 1 also shows the apparent IXR (IXRA), which, for C3, was calculated based on a thickness-weighted average IXR of the layers.

Comparative Example C2 was biaxially stretched after hydrolysis and acid exchange at a stretching ratio in the machine direction and a stretching ratio in the transverse direction. The stretching was performed first in the machine direction and then in the transverse direction. The machine direction stretching ratio (SR_{MD}) and the transverse direction stretching ratio (SR_{TD}) for C2 is listed in Table 1. The other comparative examples were unstretched.

TABLE 1
Film Properties and Stretching Ratios of Comparative Examples

| Example | | | T1 | | | T2 | | | |
|---|---|---|---|---|---|---|---|---|---|
| No. | EW1 | IXR1 | (μm) | EW2 | IXR2 | (μm) | IXRA | SR_{MD} | SR_{TD} |
| C1 | 1000 | 13.1 | 51 | N/A | N/A | N/A | 13.1 | N/A | N/A |
| C2 | 1000 | 13.1 | 51 | N/A | N/A | N/A | 13.1 | 2.4 | 2.4 |
| C3 | 1500 | 23.1 | 25 | 1000 | 13.1 | 127 | 14.8 | N/A | N/A |
| C4 | 1000 | 13.1 | 51 | N/A | N/A | N/A | 13.1 | N/A | N/A |

N/A = not applicable

The dry membrane thickness (TF) was measured for each comparative example, with the measurements being shown in Table 4. For C2, the dry membrane thickness is after stretching. Each comparative example was then evaluated for through-plane conductivity and vanadyl ion permeability. Ionic selectivity was calculated from the through-plane conductivity and vanadyl ion permeability values. The measured values for through-plane conductivity (σ_{T}) and vanadyl ion permeability (P_{VO}²⁺) and the calculated value for ionic selectivity (IS) are shown in Table 2.

TABLE 2
Membrane Properties of Comparative Examples

| Example | TF | σ_{T} | P_{VO}²⁺ | IS |
|---|---|---|---|---|
| No. | (μm) | (mS/cm) | (10⁻⁶ cm²/min) | (10⁶ mS min/cm³) |
| C1 | 51 | 87.0 | 1.600 | 54 |
| C2 | 51 | 81.0 | 0.666 | 122 |
| C3 | 152 | 50.1 | 0.534 | 94 |
| C4 | 51 | 70.0 | 1.650 | 42 |

C1 is a conventional benchmark cast film for comparison. The stretched single layer film of C2 shows a significant reduction in the vanadyl ion permeability with only a slight reduction in the through-plane conductivity, and hence a significant increase in ionic selectivity compared to the cast film of C1. The unstretched two-layer film of C3 has an even lower vanadyl ion permeability but also a significantly lower through-plane conductivity than the stretched single layer film of C2 and hence a lower ionic selectivity than C2. The single layer extruded film of C4 has a similar vanadyl ion permeability to the cast film of C1 but a lower through-plane conductivity than C1 and hence the worst ionic selectivity of the four comparative examples.

### Inventive Examples

Each inventive example included a first film of a first thickness (T1) of a TFE/PSEPVE ionomer containing sulfonate or sulfonic acid groups having a first ion exchange ratio (IXR1) and a second film of a second thickness (T2) of a TFE/PSEPVE ionomer containing sulfonate or sulfonic acid groups having a second ion exchange ratio (IXR2) less than the first ion exchange ratio (IXR1). Inventive Examples 19-22 were tri-layers that also included a third film of a third thickness (T3) of a TFE/PSEPVE ionomer containing sulfonate or sulfonic acid groups and having a third ion exchange ratio (IXR3). For the inventive examples, the IXR values of 10.1, 10.8, 11.5, 17.1, and 23.1 corresponded to EW values of 850, 885, 920, 1200, and 1500, respectively. The films of Inventive Examples 1-12, 17, and 19-22 were sized and hot pressed together. The films of Inventive Examples 13-16 and 18 were melt coextruded. Table 3 shows the equivalent weight (EW), ion exchange ratio, and thickness for the layers of each inventive example prior to hot pressing. Table 3 also shows the apparent IXR (IXRA) calculated based on a thickness-weighted average IXR of the layers. The inventive examples had a first film thickness in the range of 13 μm to 64 μm, a first ion exchange ratio in the range of 11.5-23.1, a second film thickness in the range of 64 μm to 178 μm, and a second ion exchange ratio in the range of 10.1 to 17.1. The difference between the first ion exchange ratio and the second ion exchange ratio was in the range of 1.4 to 13.0.

The hot-pressed inventive examples were prepared by hot pressing two or three unhydrolyzed (sulfonyl fluoride form) films at a hot pressing temperature in the range of about 200° C. to about 250° C. under a pressure in the range of about 3500 to 5000 pounds of force for about 5 to 7 minutes. The pressed films were then hydrolyzed and acid exchanged prior to the stretching. The co-extruded films were hydrolyzed and acid exchanged after the coextrusion but prior to the stretching.

TABLE 3
Prestretch Properties and Stretching Ratios of Inventive Examples

| Ex. | | | T1 | | | T2 | | | T3 | | | |
|---|---|---|---|---|---|---|---|---|---|---|---|---|
| No. | EW1 | IXR1 | (μm) | EW2 | IXR2 | (μm) | EW3 | IXR3 | (μm) | IXRA | SR_{MD} | SR_{TD} |
| 1 | 1500 | 23.1 | 25 | 1200 | 17.1 | 127 | N/A | N/A | N/A | 18.1 | 2.2 | 2.2 |
| 2 | 1500 | 23.1 | 25 | 1200 | 17.1 | 127 | N/A | N/A | N/A | 18.1 | 1.7 | 1.7 |
| 3 | 1200 | 17.1 | 64 | 920 | 11.5 | 64 | N/A | N/A | N/A | 14.3 | 1.7 | 1.7 |
| 4 | 1200 | 17.1 | 64 | 920 | 11.5 | 64 | N/A | N/A | N/A | 14.3 | 1.7 | 1.7 |
| 5 | 1500 | 23.1 | 25 | 850 | 10.1 | 76 | N/A | N/A | N/A | 13.4 | 1.7 | 1.7 |
| 6 | 1500 | 23.1 | 25 | 885 | 10.8 | 127 | N/A | N/A | N/A | 12.9 | 1.7 | 1.7 |
| 7 | 1500 | 23.1 | 25 | 885 | 10.8 | 127 | N/A | N/A | N/A | 12.9 | 2.7 | 2.7 |
| 8 | 1200 | 17.1 | 51 | 885 | 10.8 | 127 | N/A | N/A | N/A | 12.6 | 2.2 | 2.2 |
| 9 | 1200 | 17.1 | 51 | 885 | 10.8 | 127 | N/A | N/A | N/A | 12.6 | 1.7 | 1.7 |
| 10 | 1200 | 17.1 | 51 | 885 | 10.8 | 127 | N/A | N/A | N/A | 12.6 | 1.7 | 1.7 |
| 11 | 1200 | 17.1 | 13 | 885 | 10.8 | 127 | N/A | N/A | N/A | 11.4 | 1.5 | 2.5 |
| 12 | 920 | 11.5 | 64 | 850 | 10.1 | 89 | N/A | N/A | N/A | 10.7 | 1.7 | 1.7 |
| 13 | 1500 | 23.1 | 25 | 1000 | 13.1 | 127 | N/A | N/A | N/A | 14.8 | 3.0 | 3.0 |
| 14 | 1500 | 23.1 | 25 | 1000 | 13.1 | 127 | N/A | N/A | N/A | 14.8 | 3.0 | 3.0 |
| 15 | 1500 | 23.1 | 25 | 1000 | 13.1 | 127 | N/A | N/A | N/A | 14.8 | 2.0 | 3.5 |
| 16 | 1500 | 23.1 | 25 | 1000 | 13.1 | 127 | N/A | N/A | N/A | 14.8 | 3.5 | 2.0 |
| 17 | 1200 | 17.1 | 51 | 885 | 10.8 | 178 | N/A | N/A | N/A | 12.2 | 1.0 | 3.0 |
| 18 | 1500 | 23.1 | 25 | 1000 | 13.1 | 127 | N/A | N/A | N/A | 14.8 | 3.0 | 3.0 |
| 19 | 1500 | 23.1 | 25 | 885 | 10.8 | 127 | 1500 | 23.1 | 25 | 14.3 | 1.7 | 1.7 |
| 20 | 1500 | 23.1 | 25 | 885 | 10.8 | 127 | 1500 | 23.1 | 25 | 14.3 | 2.2 | 2.2 |
| 21 | 1500 | 23.1 | 25 | 850 | 10.1 | 89 | 1500 | 23.1 | 25 | 14.8 | 1.7 | 1.7 |
| 22 | 1200 | 17.1 | 25 | 850 | 10.1 | 89 | 1200 | 17.1 | 25 | 12.7 | 1.7 | 1.7 |

N/A = not applicable

After hydrolysis and ion exchange following film formation, each multi-layer film, except for Inventive Example 17, was biaxially stretched at a stretching ratio in the machine direction and a stretching ratio in the transverse direction. For the inventive examples, the multi-layer films were stretched on a lab-scale biaxial Brückner Karo VI stretcher (Brückner Maschinenbau GmbH, Siegsdorf, Germany). The films were stretched at 140° C. for all inventive examples, except for Inventive Examples 13 and 14, which were stretched at 125° C. and 150° C., respectively. The films were stretched at a draw rate of 5% per second for all inventive examples, except for Inventive Examples 4 and 9, which were stretched at 1% and 10% per second, respectively. All films were subsequently annealed at 10° C. higher than their respective stretching temperature. Inventive Example 17 was only stretched in the transverse direction.

The machine direction stretching ratio (SR_{MD}) and the transverse direction stretching ratio (SR_{TD}) for each inventive example is listed in Table 3. The inventive examples had a stretching ratio in the range of 1.0 to 3.5 in the machine direction and in the range of 1.7 to 3.5 in the transverse direction. The machine direction stretching and the transverse direction stretching were done simultaneously for all biaxially stretched inventive examples, except for Inventive Example 11, which was first stretched in the machine direction and then in the transverse direction.

After stretching, the dry thickness of each inventive example except for Inventive Examples 14-16 was measured. The measured dry membrane thicknesses (TF) are shown in Table 4. The measured dry thicknesses were in the range of 24 to 112 μm. The thicknesses of Inventive Examples 14-16 were not measured until after the vanadium permeability tests and were 45 μm, 79 μm, and 36 μm, respectively. Each inventive example was then evaluated for through-plane conductivity and vanadyl ion permeability. Ionic selectivity was calculated from the through-plane conductivity and vanadyl ion permeability values. The measured values for through-plane conductivity (σ_{T}) and vanadyl ion permeability (P_{VO}²⁺) and the calculated value for ionic selectivity (IS) are shown in Table 4.

The inventive examples all had a lower vanadyl ion permeability and a higher ionic selectivity than the cast film Comparative Example C1 and the extruded single layer film Comparative Example C4. The through-plane conductivity of the inventive examples was in the range of 25.3 to 131.3 mS/cm. The vanadyl ion permeability of the inventive examples was in the range of 0.101 to 1.364 10⁻⁶ cm²/min. The ion selectivity of the inventive examples was in the range of 55-347 10⁶ mS min/cm³.

TABLE 4
Stretched Film Properties of Inventive Examples

| Example | TF | σ_{T} | P_{VO}²⁺ | Ionic Selectivity |
|---|---|---|---|---|
| No. | (μm) | (mS/cm) | (10⁻⁶ cm²/min) | (10⁶ mS min/cm³) |
| 1 | 40 | 34.9 | 0.101 | 347 |
| 2 | 71 | 41.9 | 0.151 | 278 |
| 3 | 47 | 41.8 | 0.681 | 61 |
| 4 | 51 | 68.9 | 0.417 | 165 |
| 5 | 45 | 42.4 | 0.766 | 55 |
| 6 | 68 | 55.6 | 0.204 | 272 |
| 7 | 24 | 48.4 | 0.181 | 268 |
| 8 | 36 | 83.1 | 0.650 | 128 |
| 9 | 58 | 131.3 | 1.052 | 125 |
| 10 | 68 | 107.3 | 1.055 | 102 |
| 11 | 41 | 93.3 | 1.020 | 91 |
| 12 | 47 | 92.2 | 1.346 | 69 |
| 13 | 27 | 25.3 | 0.228 | 111 |
| 14 | N/D | 57.4 | 0.312 | 184 |
| 15 | N/D | 30.0 | 0.376 | 80 |
| 16 | N/D | 43.4 | 0.272 | 159 |
| 17 | 65 | 97.2 | 1.049 | 93 |
| 18 | 30 | 46.8 | 0.241 | 194 |
| 19 | 112 | 42.7 | 0.185 | 230 |
| 20 | 27 | 26.4 | 0.162 | 163 |
| 21 | 58 | 34.3 | 0.142 | 241 |
| 22 | 48 | 98.9 | 0.828 | 119 |

N/D = not determined

All above-mentioned references are hereby incorporated by reference herein.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A cation exchange membrane comprising a stretched film comprising at least two layers of fluorinated ionomer containing sulfonate or sulfonic acid groups, said layers having differing ion exchange ratio values which define one or more high ion exchange ratio layers and one or more low ion exchange ratio layers, said high and low ion exchange ratio layers differing in ion exchange ratio by at least about 1.

2. The membrane of claim 1, wherein the stretched film has an apparent ion exchange ratio in the range of about 7.1 to about 25.2.

3. The membrane of claim 2, wherein the apparent ion exchange ratio is in the range of about 9.1 to about 23.2.

4. The membrane of any of claims 1-3, wherein said high and low ion exchange ratio layers of fluorinated ionomer containing sulfonate or sulfonic acid groups differing in ion exchange ratio by at least at least about 2.

5. The membrane of claim 1, where the one or more low ion exchange ratio layer has an ion exchange ratio of at most about 17.2.

6. The membrane of claim 1, where the one or more high ion exchange ratio layers has an ion exchange ratio of at least about 11.1.

7. The membrane of claim 1, where the stretched film is biaxially stretched.

8. The membrane of claim 1, where the stretched film comprises at least two high ion exchange ratio layers.

9. The membrane of claim 8, where the at least two high ion exchange ratio layers have equivalent ion exchange ratios.

10. The membrane of claim 1, where the thickness of the one or more low ion exchange ratio layers is greater than or equal to the thickness of the one or more high ion exchange ratio layers.

11. The membrane of claim 1 having a membrane thickness after stretching in the range of about 10 μm to about 200 μm.

12. The membrane of claim 1, wherein said membrane is unreinforced.

13. A process for making a cation exchange membrane comprising a stretched film, said process comprising:
forming a film comprising at least two layers of fluorinated ionomer containing sulfonate or sulfonic acid groups to form a multi-layer film; and
stretching the multi-layer film;
wherein said layers have differing ion exchange ratio values which define one or more high ion exchange ratio layers and one or more low ion exchange ratio layers, said high and low ion exchange ratio layers differing in ion exchange ratio by at least about 1.

14. The process of claim 13, further comprising the step of heating the multi-layer film to a temperature not lower than 20° C. below the glass transition temperature of the fluorinated ionomer.

15. The process of claim 13 or 14, where the stretching is carried out at a rate of about 1%/sec to about 200%/sec.

16. The process of claim 13, wherein the apparent ion exchange ratio of the layers of fluorinated ionomer containing sulfonate or sulfonic acid groups is about 7.1 to about 25.2.

17. An electrochemical cell having anode and cathode compartments and comprising a cation exchange membrane as a separator between said anode and cathode compartments, said membrane comprising a stretched film comprising at least two layers of fluorinated ionomer containing sulfonate or sulfonic acid groups, said layers having differing ion exchange ratio values which define one or more high ion exchange ratio layers and one or more low ion exchange ratio layers, said high and low ion exchange ratio layers differing in ion exchange ratio by at least about 1.

18. The electrochemical cell of claim 17, where the electrochemical cell is selected from the group consisting of a redox flow battery cell, a fuel cell, a chloralkali cell, and a water electrolysis cell.

19. The electrochemical cell of claim 18, wherein said electrochemical cell is a redox flow battery cell.

20. The electrochemical cell of claim 19, wherein said redox flow battery cell is a vanadium redox flow battery cell.
